(19) United States
(12) Patent Application Publication
(10) Pub. No.: US 2006/0050299 A1
(43) Pub. Date: Mar. 9, 2006

(54) Internet facsimile communication system, internet facsimile communication method and storage medium storing internet facsimile communication program

(75) Inventors: Yasushi Sakata, Saitama (JP); Hironori Niwa, Saitama (JP); Ryuji Inaba, Saitama (JP); Tsuyoshi Mizoi, Saitama (JP); Kouji Yorimoto, Saitama (JP); Hidetaka Hama, Saitama (JP)

Correspondence Address: OLIFF & BERRIDGE, PLC, P.O. BOX 19928, ALEXANDRIA, VA, 22320, US

(73) Assignee: FUJI XEROX CO., LTD., TOKYO (JP)

(21) Appl. No.: 11/200,016

(22) Filed: Aug. 10, 2005

(30) Foreign Application Priority Data
Sep. 9, 2004 (JP) 2004-262536

(51) Int. Cl. G06F 3/12

(52) U.S. Cl. 358/1.15

(57) ABSTRACT

An Internet facsimile communication system for sending a document from a sending device to a receiving device via an Internet mail, in which the sending device includes a sending unit that sends the document with urgent designation information added thereto to the receiving device; and the receiving device includes: an information unit that informs reception of an urgent document if the document received from the sending device has the urgent designation information attached thereto; and a print control unit that immediately prints out the received document about which the reception of the urgent document has been informed by the information unit.

### BACKGROUND OF THE INVENTION

1. Field of the Invention

The present invention relates to an Internet facsimile communication system, an Internet facsimile communication method and a storage medium storing an Internet facsimile communication program which perform facsimile communication over the Internet communication network, and more particularly to an Internet facsimile communication system, an Internet facsimile communication method and a storage medium storing an Internet facsimile communication program which, in urgent mode, enables the reception confirmation by notifying an output completion.

2. Description of the Related Art

Recently, a facsimile communication using the Internet is spreading rapidly because the communication cost can be reduced considerably in comparison with the facsimile communication using a conventional telephone line. The Internet-using facsimile communication (hereinafter referred to as the Internet FAX) is performed for sending and receiving via a mail server, so that transmission can be made to everywhere all over the world in the same manner as electronic mail and multi-address transmission and transfer can be conducted.

But, when the use rate of the Internet communication line is high or a transmission loss rate is high, there are problems that transmission time changes largely, reception is not made normally because the line is electrically disconnected and the like.

There is a related art disclosed in Japanese Patent Application Laid-Open No. H09-247335 that a mail reception acknowledgement notice, a received mail print failure notice, a mail attachment expansion failure notice and the like can be sent back to a sender.

In addition, the related art disclosed in Japanese Patent Application Laid-Open No. H09-247335 can set whether the received e-mail is wholly printed or only a part of it is printed.

The related art disclosed in Japanese Patent Application Laid-Open No. H09-247335, however, has a drawback that a sender who has sent e-mail can check the transmission of the e-mail but the reception is not confirmed because the reception might not be recognized by a recipient even if the e-mail is printed on the side of the recipient.

### SUMMARY OF THE INVENTION

Accordingly, the present invention has been made in view of the above circumstances and provides an Internet facsimile communication system, an Internet facsimile communication method and a storage medium storing an Internet facsimile communication program that enables, in an urgent mode, the reception acknowledgement by notifying an output completion.

An aspect of the present invention provides an Internet facsimile communication system for sending a document from a sending device to a receiving device via an Internet mail, in which the sending device includes a sending unit that sends the document with urgent designation information added thereto to the receiving device; and the receiving device includes: an information unit that informs reception of an urgent document if the document received from the sending device has the urgent designation information attached thereto; and a print control unit that immediately prints out the received document about which the reception of the urgent document has been informed by the information unit.

### BRIEF DESCRIPTION OF THE DRAWINGS

Embodiments of the present invention will be described in detail based on the following figures, wherein:

FIG. 1 is a view showing a network structure configured by applying an Internet FAX communication system, communication control method and communication control program according to an embodiment of the present invention;

FIG. 2 is a view showing a system structure of an Internet FAX communication system according to an example of the present invention;

FIG. 3 is a view of a screen showing reception of an Internet FAX document requiring urgent communication;

FIG. 4 is a view showing the contents of the header of e-mail indicating the Internet FAX requiring urgent communication;

FIG. 5 is a sequence view showing a processing transition between a sender and a recipient;

FIG. 6 is a flow chart showing a flow of processing on the side of a sender; and

FIG. 7 is a flow chart showing a flow of processing on the side of a recipient.

### DETAILED DESCRIPTION OF THE INVENTION

An embodiment of an Internet facsimile communication system, an Internet facsimile communication method and an Internet facsimile communication program according to the present invention will be described in detail with reference to the accompanying drawings.

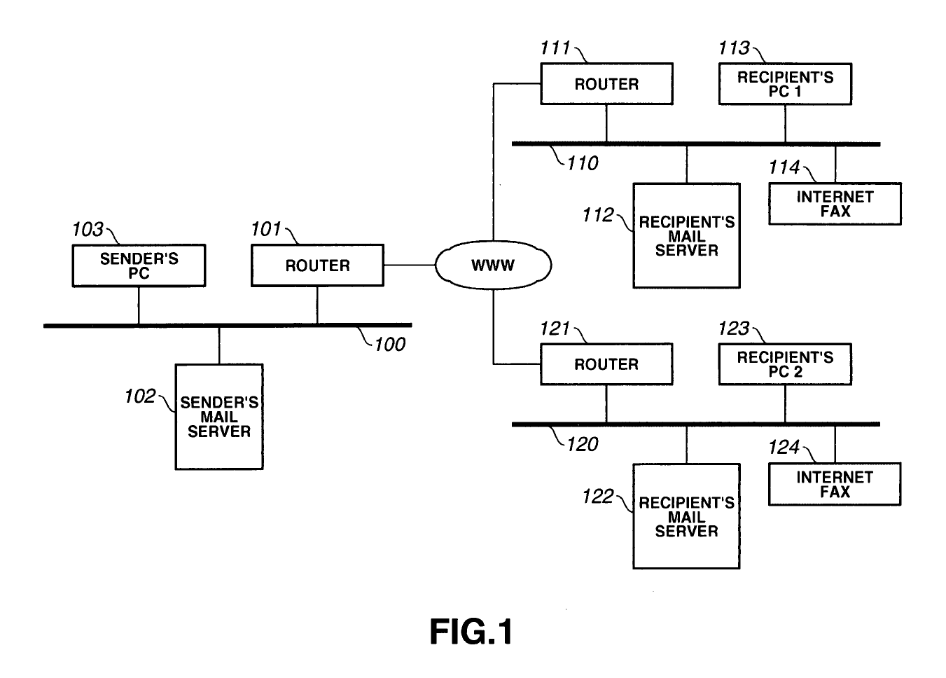

FIG. 1 is a view of a network structure configured by applying the Internet facsimile communication system, method and program according to the present invention.

In FIG. 1, this network comprises a sender network 100 which sends a document by an Internet FAX which is a facsimile communication over the Internet and recipient's networks (110, 120) which receive a document by an Internet FAX from the sender's network 100.

The recipient's network is not limited to the above two networks, and reception can be made via plural networks.

The sender's network 100 is comprised of a router 101, a sender's mail server 102 and a sender PC (Personal Computer) 103.

The router 101 is a communication device which mutually connects networks.

The sender's mail server 102 is a control device which is used to send an Internet FAX document by using e-mail. When the sender's mail server 102 receives a transmission request by the Internet FAX from the sender's PC 103, it analyzes the destination and sends to the sender by using the e-mail technology.

At the time of transmission, the destination is listed, and the destination and the contents of the sent mail are managed, and the sent time is also managed to check whether the communication has been made without fail.

The sender's PC 103 generates an Internet FAX document and, when the Internet FAX document is urgent, urgent designation information is added to e-mail. The urgent designation information assigns an area capable of designating a communication level to the header of the e-mail and designates information indicating that the mail is urgent communication in the pertinent area.

Indication of urgent communication is not limited to the assignment of an area in the header of the mail but a message indicating urgent communication may be added to an Internet FAX document, or a message indicating urgent communication may be added to the main body of the e-mail.

In addition, it may be configured to send a message indicating urgent communication at the same time when an Internet FAX document is sent.

The recipient's network 110 and the recipient's network 120 each are comprised of a router (111, 121), a recipient's mail server (112, 122), a recipient's PC (113, 123) and an Internet FAX device (114, 124).

The router (111, 121) is an interface to connect networks mutually.

The recipient's mail server (112, 122) receives an Internet FAX document being sent from the sender's network 100 and controls the communications. The recipient's mail server (112, 122) analyzes the received Internet FAX e-mail and judges whether or not it is urgent communication. If it is urgent communication, the recipient's mail server (112, 122) controls to process urgently, but if not, it controls in the same manner as an ordinary Internet FAX.

In case of an urgent communication, an Internet FAX document is output, and it is judged whether or not printing was made normally by an Internet FAX output device. If printing was made normally, it is sent to the sender's mail server 102.

The recipient's PC (113, 123) is an ordinary personal computer, and when Internet FAX which is an urgent communication is received by the recipient's mail server (112, 122), it is indicated on the PC. The recipient's PC (113, 123) is not limited to a personal computer but indicates a receiving device.

The Internet FAX device (114, 124) outputs the Internet FAX document received by the recipient's mail server (112, 122).

To output, a G3 FAX (Group 3 facsimile: facsimile using an analog line), a G4 FAX (Group 4 facsimile: facsimile using a digital line), a printer or the like is used. As to the Internet FAX, when the received document can be processed normally, an output completion notice indicating normal termination is sent to the recipient's mail server (112, 122).

Thus, even if the Internet FAX requires urgent communication, the establishment of communication and normal printout can be confirmed, and the reception and output of the urgent communication Internet FAX document to the recipient can be transmitted.

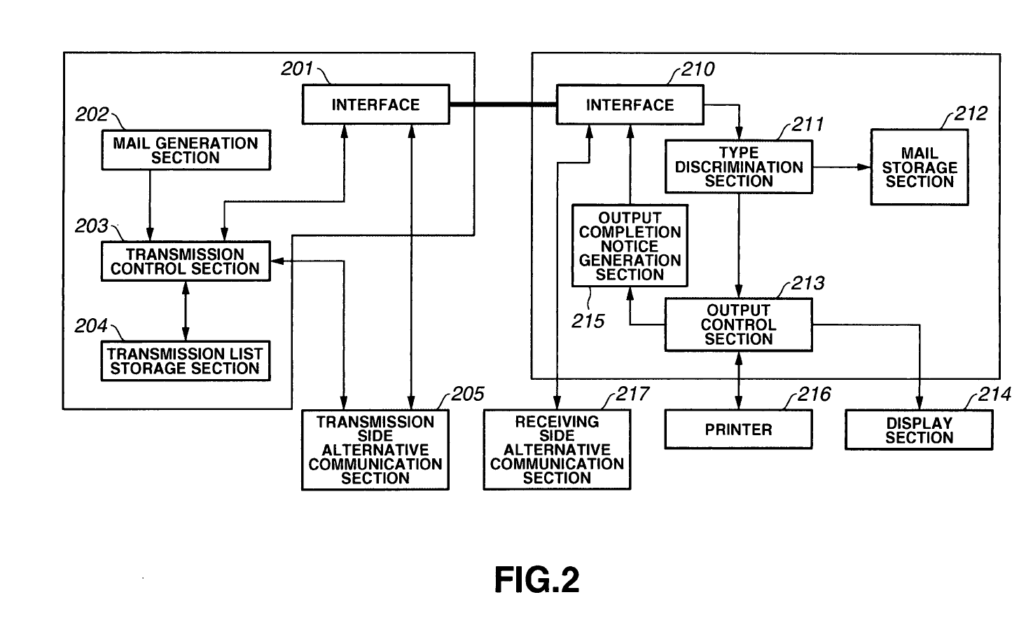

FIG. 2 is a view showing a system structure of an Internet facsimile communication system according to the present invention.

FIG. 2 shows a structure view showing in detail the structures of individual nodes of the network structure shown in FIG. 1 and comprising interfaces (201, 210), a mail generation portion 202, a transmission control portion 203, a transmission list storage portion 204, a transmitting side alternative communication portion 205, a type discrimination portion 211, a mail storage portion 212, an output control portion 213, a display portion 214, an output completion notice generation portion 215, a printer 216 and a receiving side alternative communication portion 217.

The interfaces (201, 210) are external output interfaces of the Internet FAX. Communications between networks are effected via the interfaces.

The mail generation portion 202 generates an Internet FAX document and generates an Internet FAX e-mail by using e-mail technology. In case of urgent communication, a remainder that the communication is urgent is allotted to the header of the generated e-mail.

The transmission control portion 203 sends e-mail to the designated destination. And, it extracts a destination address designated for the e-mail generated by the mail generation portion 202, stores the address as destination of the e-mail in a list by the transmission list storage portion 204 and also stores the transmitted time in the list.

As to the destination of the e-mail which is indicated as urgent communication, the reception of the output completion notice from the destination is monitored. When the output completion notice is received, it is compared with the transmission list to specify a destination from which the output completion notice has not been received. A destination from which the output completion notice has not been received within a prescribed monitored time period is extracted, and an instruction is sent so as to make communications to the destination by the transmitting side alternative communication portion 205.

The transmission list storage portion 204 stores the destination address extracted by the transmission control portion 203 and the transmitted time as a list for every e-mail. The transmission control portion 203 keeps comparing the time of sending e-mail and a prescribed time period to specify a destination which has not sent an output completion notice after the expiration of the prescribed time period.

The transmitting side alternative communication portion 205 is a communication means which contacts the destination from which the output completion notice is not received within the prescribed time by monitoring the output completion notice from the destination by the transmission control portion 203.

For example, a communication is made without fail by means of a telephone using a general public line network, IP phone using the Internet connection, or a portable phone or a beeper if a user is not at the desk.

The type discrimination portion 211 analyzes the area, which indicates a type of communication, allotted at the header of an Internet FAX e-mail being sent from a source, and if it is urgent communication, sends the contents of the e-mail to the output control portion 213. If it is not urgent communication, the type discrimination portion 211 judges that it is an ordinary e-mail and stores in the mail storage portion 212.

The mail storage portion 212 stores e-mail which does not require urgent communication. The stored e-mail can be checked by using a protocol such as POP3 (Post Office Protocol version 3: mail reception protocol) by recipient's e-mail software.

When it is judged by the type discrimination portion 211 that the Internet FAX requires urgent communication, the output control portion 213 causes the display portion 214 to display that effect and outputs it by the printer 216. In order to output by the printer 216, the output control portion 213 controls to output by using sheets in a dedicated tray to clarify the necessity of urgent communication. For example, special color sheets are set in the dedicated tray, so that it is easy to visually judge that the Internet FAX document is urgent communication when it is printed on the color sheet.

After printing, it is checked whether the printer 216 could output normally, and when a normal termination signal is received from the printer, the normal termination signal is sent to the output completion notice generation portion 215.

Upon receiving the Internet FAX e-mail requiring urgent communication, the display portion 214 displays that effect on the screen. When the user refers to the displayed screen and confirms that the printer has output (e.g., OK button is pressed), a confirmation signal is sent to the output control portion 213.

When the output completion notice generation portion 215 receives the normal termination signal from the printer 216 and the confirmation signal from the display portion 214, it judges that the processing has been made normally and the recipient has confirmed it and generates an output completion notice. The generated output completion notice is sent to the sender.

The printer 216 outputs the Internet FAX document which is received as e-mail. It may be configured to output with an alarm or the like generated when the Internet FAX requires urgent communication.

The receiving side alternative communication portion 217 communicates by the communication means used by the transmitting side alternative communication portion 205.

By configuring as described above, it can be checked whether the Internet FAX document is received normally and that the output of the received Internet FAX document by the printer 216 is confirmed, and a destination that output completion is not made can be specified.

In addition, by using the special color sheets and special alarm at the time of printing, the recipient can be notified and the reception of the Internet FAX document requiring urgent communication can also be notified immediately.

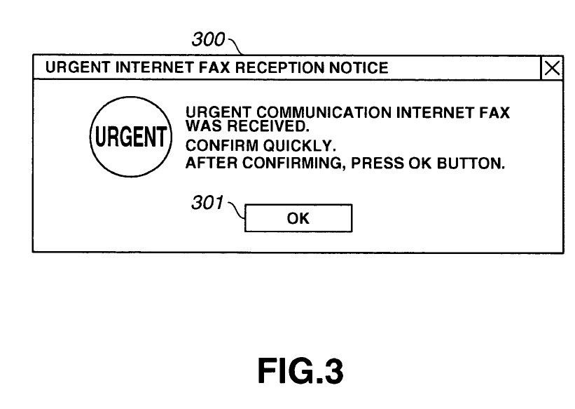

FIG. 3 is a view of a screen showing an Internet FAX document requiring urgent communication is received.

FIG. 3 shows a screen displayed on a recipient's PC when an Internet FAX document requiring urgent communication is received. When this screen is displayed, the user checks the Internet FAX machine and confirms the Internet FAX document requiring urgent communication.

The screen shown in FIG. 3 has a message indicating the reception of an Internet FAX requiring urgent communication and an OK button 301.

When the OK button 301 is pressed, it is judged that the reception of the Internet FAX document is confirmed, and a confirmation signal is sent to the output control portion 213 shown in FIG. 2.

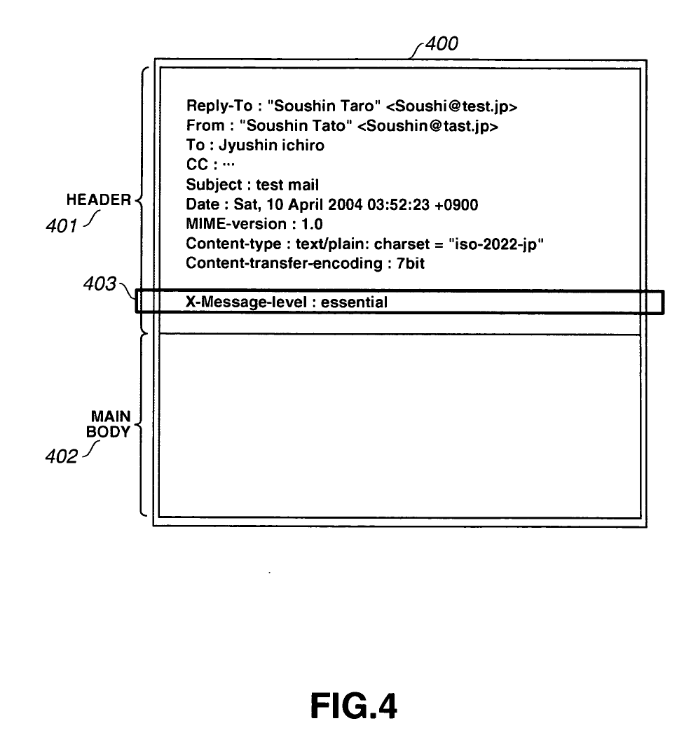

FIG. 4 is a view showing the contents of the header of e-mail indicating that the Internet FAX requires urgent communication.

Internet FAX e-mail 400 shown in FIG. 4 is comprised of a header 401 and a main body 402.

The header 401 shows information such as an e-mail destination and has a communication level item 403.

The communication level item 403 can designate whether the mail is urgent communication or ordinary communication.

For example, FIG. 4 shows “X-Message-level” as an item indicating a communication level and “essential” in its contents. It indicates that the communication level is urgent, and this e-mail is judged as an Internet FAX requiring urgent communication by the type discrimination portion 211 shown in FIG. 2.

When the contents include “ordinary”, no designation or no item indicating a communication level, e-mail is judged as normal and processed accordingly.

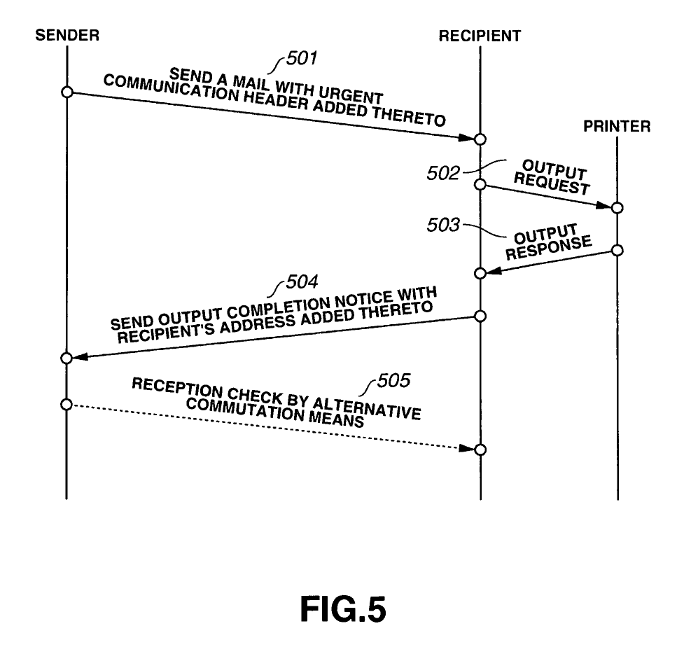

FIG. 5 is a sequence view showing a processing transition between a sender and a recipient.

FIG. 5 shows a sequence among the sender, the recipient and the printer. When the sender designates that the Internet FAX requires urgent communication and sends it to the recipient (S501), the recipient checks the communication content and sends an output request to an Internet FAX conforming printer (S502). The printer having received the output request outputs the Internet FAX document, and the output result is output to respond to the recipient (S503). The recipient having received the output response checks the output Internet FAX document and presses the OK button 301 on the screen shown in FIG. 3. The received recipient's address is added to the output completion notice, which is then sent (S504).

The sender checks the reception by using an alternative communication means with respect to the recipient from which an output completion notice is not sent even after a lapse of a prescribed time (S505).

The above-described reception check by using the alternative communication means is conducted only on the recipient from which an output completion notice is not sent. Therefore, when the output completion notice is sent from all the recipients, the reception check is not made.

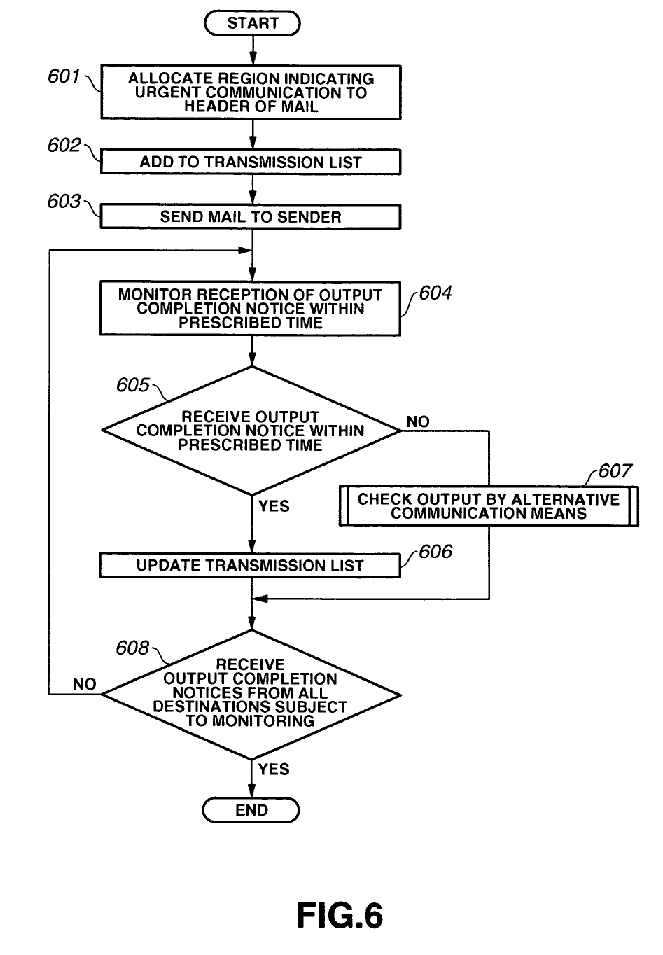

FIG. 6 is a flow chart showing a flow of processing on the side of the sender.

In FIG. 6, when an Internet FAX document is generated, processing is started. When the Internet FAX document is designated as urgent communication at the time of sending by the e-mail technology, an item indicating urgent communication is allotted to a region of the header of the e-mail (S601), the Internet FAX document sent to the destination and the transmission starting time are added to the transmission list (S602). The Internet FAX indicating urgent communication is sent to the recipient by using the e-mail technology (S603).

It is monitored whether an output completion notice of the Internet FAX document added to the transmission list is received within the prescribed time (S604), it is judged whether the output completion notice is received within the prescribed time (S605). If the output completion notice is received (YES in S605), the transmission list of the destination having received the output completion notice is updated (S606). If the output completion notice is not received within the prescribed time (NO in S605), the alternative communication means is used to make output check whether the Internet FAX document requiring urgent communication is output (S607).

It is judged whether all output completion notices from the destinations being managed by the transmission list have been sent (S608), and if they have been sent (YES in S608), the processing is terminated. Meanwhile, if the output completion notice is not received from at least one destination (NO in S608), the processing (S604) of monitoring the reception of the output completion notice and the following are repeated.

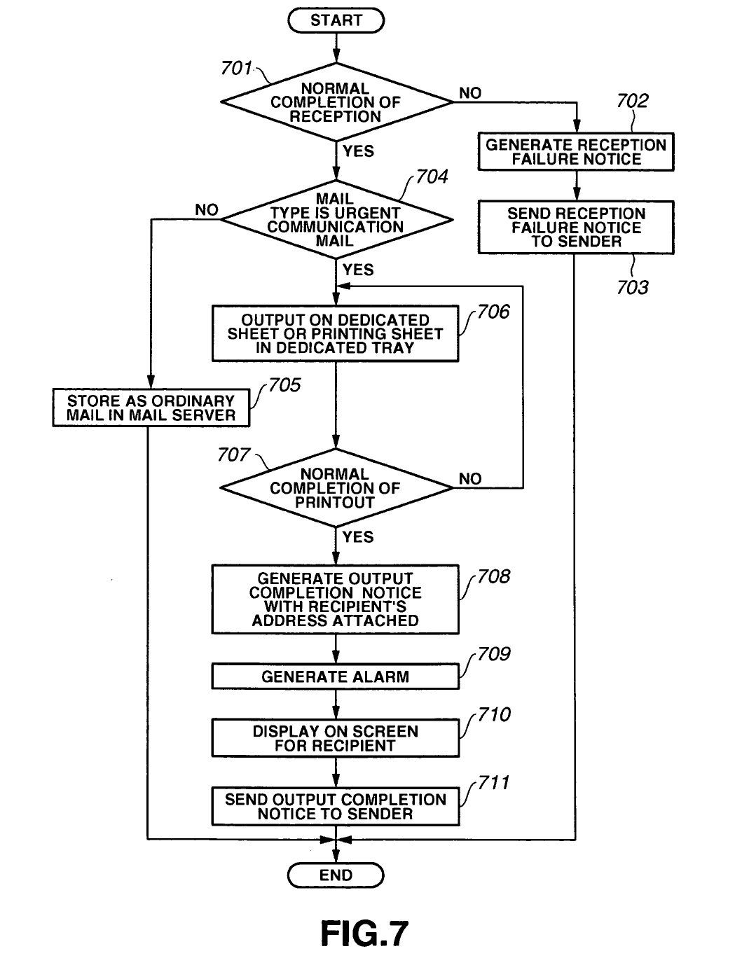

FIG. 7 is a flow chart showing a flow of processing on the side of a recipient.

In FIG. 7, when an Internet FAX document is received from a sender by using the e-mail technology, processing is started, it is judged whether the sent e-mail is received normally (S701), and if not received normally (NO in S701), it is judged that a communication error has occurred, a reception failure notice indicating a reception failure is generated (S702), and the generated reception failure notice is sent to the sender (S703).

If the e-mail is received normally (YES in S701), a communication level is judged (S704), and when it is ordinary e-mail not requiring urgent communication (NO in S704), it is judged as ordinary mail, the mail is stored in the mail server, and the processing is terminated (S705). Meanwhile, if the mail is urgent communication mail requiring urgent communication (YES in S704), it is printed on a dedicated sheet in the dedicated tray of the printer conforming to the Internet FAX (S706). It is judged whether its printout has completed normally (S707), and if not completed normally (NO in S707), printing is made again (S706).

When the printout is completed normally (YES in S707), an output completion notice with the recipient's address attached is generated to the sender (S708). At the same time, an alarm is generated by an output device which prints out (S709), and a message indicating-the reception of the urgent communication is displayed on the screen for the recipient (S710). Then, the generated output completion notice is sent to the sender (S711).

By processing as described above, the communication control device of the present invention can check that the Internet FAX document has been output without fail and the transmission of information by the recipient can be checked.

Accordingly, a destination from which an output completion notice is not given even after a lapse of a prescribed time can be specified, and it can be checked by using the alternative communication means whether communication has been made to the destination.

The processing indicated by the above-described flow chart can also be realized by a communication control program executable by a computer.

As described above, a first aspect of the present invention provides an Internet facsimile communication system for sending a document from a sending device to a receiving device via an Internet mail, in which the sending device includes a sending unit that sends the document with urgent designation information added thereto to the receiving device; and the receiving device includes: an information unit that informs reception of an urgent document if the document received from the sending device has the urgent designation information attached thereto; and a print control unit that immediately prints out the received document about which the reception of the urgent document has been informed by the information unit.

A second aspect of the present invention provides the Internet facsimile communication system according to the first aspect of the invention, in which the receiving device may further include a notification unit that informs an output completion notice to the sending device if the received document having the urgent designation information attached thereto was normally printed out by the print control unit; and the sending unit may further include a judging unit that monitors reception of the output completion notice and, if the output completion notice was not received within a prescribed time, judges as a transmission error of the document having the urgent designation information attached thereto.

A third aspect of the present invention provides an Internet facsimile communication method for sending a document from a sending device to a receiving device via an Internet mail, the method including: sending the document with urgent designation information attached thereto by a sending unit of the sending device to the receiving device; informing the reception of an urgent document by an information unit of the receiving device if the document received from the sending device has urgent designation information attached thereto; immediately printing out the received document about which the information unit has informed the reception of the urgent document by a print control unit of the receiving device; notifying an output completion notice to the sending device by a notification unit of the receiving device if the received document having the urgent designation information attached thereto was normally printed out by the print control unit; and judging as a transmission error of the document having the urgent designation information attached thereto by a judging unit of the sending device if the reception of the output completion notice being monitored by the sending unit was not received within a prescribed time.

A fourth aspect of the present invention provides a storage medium readable by a computer, the storage medium storing an Internet facsimile communication program of instructions executable by the computer to perform a function for Internet facsimile communication to send a document from a sending device to a receiving device via an Internet mail, the function including: sending the document with urgent designation information attached thereto from the sending device to the receiving device; informing the reception of an urgent document by the receiving device if the document received from the sending device has the urgent designation information attached thereto; immediately printing out the received document about which the reception of the urgent document has been informed; notifying an output completion notice from the receiving device to the sending device if the received document which has the urgent designation information attached thereto was normally printed out; and judging by the sending device as a transmission error of the document having the urgent designation information attached thereto if the reception of the output completion notice being monitored was not received within a prescribed time.

According to the above-mentioned aspects of the present invention, it is configured that urgent designation information is attached to the outgoing document of the Internet FAX requiring urgent communication, a destination is listed, and the reception of an output completion notice from the destination is monitored, thereby providing effects that a destination not sending back the output completion notice can be specified, and it is possible to check whether the destination has received the FAX.

The present invention is not limited to the embodiments described above and shown in the drawings and various modifications may be made without deviating from the spirit and scope of the invention.

For example, the above-described embodiments are configured to display the reception of an Internet FAX document requiring urgent communication on the recipient's PC. But, it may be configured to notify another user if the user on the side of the recipient is not at the desk or the like and cannot check the urgent communication immediately.

The present invention can be applied to an Internet facsimile communication system, method and program which conduct facsimile communications over the Internet, and the invention is particularly useful to allow to transmit information securely by checking the output of the Internet facsimile communication document if the Internet facsimile communication requires urgent communication.

The foregoing description of the embodiments of the present invention has been provided for the purpose of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling other skilled in the art to understand the invention for various embodiments and with the various modifications as are suited to the particular use contemplated. It is intended that the scope of the invention be defined by the following claims and their equivalents.

The entire disclosure of Japanese Patent Application No. 2004-262536 filed on Sep. 9, 2004 including specification, claims, drawings and abstract is incorporated herein by reference in its entirety.

What is claimed is:

1. An Internet facsimile communication system for sending a document from a sending device to a receiving device via an Internet mail, wherein:
the sending device comprises a sending unit that sends the document with urgent designation information added thereto to the receiving device; and
the receiving device comprises:
an information unit that informs reception of an urgent document if the document received from the sending device has the urgent designation information attached thereto; and
a print control unit that immediately prints out the received document about which the reception of the urgent document has been informed by the information unit.

2. The internet facsimile communication system according to claim 1, wherein:
the receiving device further comprises a notification unit that informs an output completion notice to the sending device if the received document having the urgent designation information attached thereto was normally printed out by the print control unit; and
the sending unit further comprises a judging unit that monitors reception of the output completion notice and, if the output completion notice was not received within a prescribed time, judges as a transmission error of the document having the urgent designation information attached thereto.

3. An internet facsimile communication method for sending a document from a sending device to a receiving device via an Internet mail, comprising:
sending the document with urgent designation information attached thereto by a sending unit of the sending device to the receiving device;
informing the reception of an urgent document by an information unit of the receiving device if the document received from the sending device has urgent designation information attached thereto;
immediately printing out the received document about which the information unit has informed the reception of the urgent document by a print control unit of the receiving device;
notifying an output completion notice to the sending device by a notification unit of the receiving device if the received document having the urgent designation information attached thereto was normally printed out by the print control unit; and
judging as a transmission error of the document having the urgent designation information attached thereto by a judging unit of the sending device if the reception of the output completion notice being monitored by the sending unit was not received within a prescribed time.

4. A storage medium readable by a computer, the storage medium storing an Internet facsimile communication program of instructions executable by the computer to perform a function for Internet facsimile communication to send a document from a sending device to a receiving device via an Internet mail, the function comprising:
sending the document with urgent designation information attached thereto from the sending device to the receiving device;
informing the reception of an urgent document by the receiving device if the document received from the sending device has the urgent designation information attached thereto;
immediately printing out the received document about which the reception of the urgent document has been informed;
notifying an output completion notice from the receiving device to the sending device if the received document which has the urgent designation information attached thereto was normally printed out; and
judging by the sending device as a transmission error of the document having the urgent designation information attached thereto if the reception of the output completion notice being monitored was not received within a prescribed time.
